(19) United States
(12) Patent Application Publication
(10) Pub. No.: US 2012/0191513 A1
(43) Pub. Date: Jul. 26, 2012

(54) Systems and Methods for Multi-Merchant Discount Payments

(76) Inventor: Alexander Ocher, San Jose, CA (US)

(21) Appl. No.: 13/352,282

(22) Filed: Jan. 17, 2012

Related U.S. Application Data
(60) Provisional application No. 61/434,432, filed on Jan. 20, 2011.

(51) Int. Cl. G06Q 20/34; G06Q 30/02

(52) U.S. Cl. 705/14.1

(57) ABSTRACT

The present invention relates to systems and methods for discount multi-merchant gift card management. The system includes registering a number of merchants, issuing a card with a unique identifier to a user after receiving a payment of a discounted amount, which is less than full face value of the card such that the user realizes the discount at the time of purchase, and pre-funding an account corresponding to each of the of merchants. The card has purchasing power equal to its face value at any of the registered merchants. The card is then used to make a purchase at a merchant, and the issuer receives a communication of the transaction, which is then processed. The card itself may be any of a smart card, a virtual card, an application on a mobile device, or a physical card.

### CROSS REFERENCE TO RELATED APPLICATION

This application claims priority to U.S. Provisional Application Ser. No. 61/434,432 filed on Jan. 20, 2011, entitled “Multi-Merchant Discount Gift Card with Multiple Interfaces”, which is hereby fully incorporated by reference.

### BACKGROUND

The present invention relates to systems and methods for multi-merchant discount payments. Such systems and methods overcome many of consumers' common complaints with traditional gift cards, and enable greater market penetration by specialty or boutique merchants. Additionally, larger merchants can benefit from such systems and methods due to an expanded customer base.

Gift cards are restricted monetary equivalents that are issued by retailers or banks to be utilized as an alternative to a non-monetary gift. The first gift cards that were supported by a payment infrastructure were employed by Blockbuster Entertainment in 1994. Since their inception, gift cards have become a staple gift, means for retaining business after a return, and in lieu of monetary compensation or reward. In fact, in 2006, over $80 billion of commerce in the United States was paid for with gift cards.

However, traditional gift cards are fraught with pitfalls to consumers that limit their usefulness. Some of these pitfalls, such as early expiration and non-use fees, arise due to the fact that retailers are able to independently set rules relating to gift card redemption. Federal legislative activity has addressed a number of these concerns, including expiration and fee limits, as well as labeling requirements. However, despite these consumer protections, issues still remain with gift cards that are intrinsic to current systems.

One of the largest concerns with gift cards, from a consumer's perspective, is that the gift card may only be redeemable at a particular retailer. Secondly, the purchase of a gift card exchanges legal tender that may be utilized virtually anywhere, for an equal value of scrip that has place and potentially time restrictions. For many consumers, this exchange is felt to be inequitable, because the consumer is giving up freedoms and apparently not getting anything in return.

In response to these consumer criticisms of gift cards, merchants and banking institutions have employed a number of potential cures. For example, banking institutions have issued their own gift cards, such as VISA® gift cards, which enable the consumer to use the gift card in a number of merchants wherever traditional VISA® credit cards are accepted. There are a few drawbacks to these banking gift cards, the major ones include reduced consumer protections, extra fees associated with these cards, and consumers view this as being too similar to giving someone cash. One major appeal to giving gift cards is that it allows some degree of personalization of the gift, while still allowing the gift recipient the ability to pick whichever item they wish. For many a gift of money is considered “cold” or impersonal, and the gift card enables the gift giver to provide a gift that is a little more personalized.

On the other front, retailers have been quick to recognize that they gain significant value from selling gift cards. Not only does the sale of a gift card by the merchant “locks in” the consumer's business, but gift cards are often lost, or not fully redeemed. Further, the delay between the purchase of the gift card and the redemption of its value is essentially an interest free loan to the retailer. As such, some retailers have been willing to provide discounts on their gift cards over their face value. For example, a retailer may sell gift cards with a face value of $50 for $45, as a limited time promotion. This addresses the consumer's concerns that they are giving up rights and getting nothing in return. The merchants are able to provide such deals because they ensure business, receive an effective interest free loan, and can count upon under redemption of issued gift cards. However, these deals can devalue the brand of the merchant, and are costly to maintain, and as such merchants limit these reduced price gift cards to promotional periods, such as during holidays. Consistent discounts are typically only offered for large “bulk” purchases of gift cards (i.e., purchases over $1000).

Additional mechanisms employed to attempt to overcome these limitations include: stored value cards that include multiple sub fields (See U.S. Pat. No. 7,512,566), methods for converting gift cards to prepaid credit cards (See US publication number 2010/0036524), discounted debit cards (See U.S. Pat. No. 7,747,524), integration of social networking with gift cards (See U.S. Pat. No. 7,953,654), automatic linking of gift cards to rebates and promotions (See US publication number 2010/0047342), among other mechanisms to make gift cards more user friendly and universally accessible.

While each of these means for addressing consumer concerns works to varying degrees for the particular concern, there is currently no means for addressing all consumer complaints of gift cards. Banking institutions, not being the retailer themselves, have fewer margins to afford providing consumer's discount cards. These issuers must rely upon card loss and the value of the interest free loan in order to generate a profit. And individual retailers are unable to issue gift cards that are accepted at a number of merchants. As such, no solution has been found that addresses the consumer's desire for increased functionality of gift cards, as well as getting something for their loss of rights.

It is therefore apparent that an urgent need exists for an improved multi-merchant payment system that enables more consumers to pay for goods and services at a wide range of participating merchants, and further purchase these alternatives to traditional gift cards at a discount.

### SUMMARY

To achieve the foregoing and in accordance with the present invention, systems and methods for multi-merchant discount payments are provided. Such systems and methods enable consumers to pay for goods and services at a wide range of participating merchants, and further purchase these alternatives to traditional gift cards at a discount.

In some embodiments, the method for operating a discount multi-merchant gift card system includes registering a number of merchants, issuing a card with a unique identifier to a user after receiving a payment of a discounted amount, which is less than full face value of the card such that the user realizes the discount at the time of purchase, and pre-funding an account corresponding to each of the merchants. The card has purchasing power equal to its face value at any of the registered merchants. The unique identifier indicates the card type.

The card is then used to make a purchase at a merchant, and the issuer receives a communication of the transaction, which is then processed. Processing may include deducting the value from the merchant's pre-funded account, or payment from some other account owned by the issuer. Some embodiments may also reconcile the transactions communicated to the issuer against actual transactions occurring in merchant systems. Prior to purchases, the card may also be activated.

The card itself may be any of a smart card, a virtual card, an application on a mobile device, or a typical physical card. If it is a smart card, it may include a chip, a transmitter, a camera, a touchscreen, and/or a power source. If capable of transmitting, the card can use the spectrum range from radio frequency to ultraviolet to transmit and small changes in EM intensity (or changes in wave length) can also be used for communications. Transmitters/receivers for this range are well known, although not all of them are currently used for gift card processing. The power source includes any of solar power, battery, fuel cell, piezoelectric materials and external voltage differentials. The power source may be contact-less, such as electromagnetic or ultrasound waves, and the resulting energy may be stored for later use. Physical cards may be plastic with an optical identifier or magnetic strip. The card may also be branded or customized. The card may also be associated with a financial account of the user. The card may also include a personal identification number.

In addition, the user may be enrolled by collecting user specific information. This information may be stored on a database along with the unique identifier for the card. The user specific information includes records for user accounts for issued cards, each record including card number, user name, user address, activation flag and remaining balance.

In some embodiments, the card may also be reloaded in response to a user request or if the balance drops below a threshold. The reloading may also be at a discount of the reloaded value.

In some embodiments, more than one card can be merged, and the transfer of card balances between different accounts. Likewise, the face value of the card may be converted to another account for a fee. The face value of the card is any of regular currency, virtual currency and a combination thereof.

In some embodiments, the card types may be based upon discount levels and merchant categories. The discounted amount may be based upon merchant popularity and/or merchant category. Further, a periodic fee may be received from the merchants in exchange for ability to participate in the program.

A database of records for the pre-funded accounts for the merchants may be maintained. Each record includes the merchant identification, account number and remaining balance. Transactions are for any of physical goods, virtual goods and services.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is an example functional block diagram for a system of multi-merchant discount payments, in accordance with some embodiments;

FIG. 2 is an example block diagram for a merchant, in accordance with some embodiments;

FIG. 3 is an example block diagram for a financial system, in accordance with some embodiments;

FIG. 4 is an example block diagram for an issuer system, in accordance with some embodiments;

FIG. 5 is a first example flow chart for the process of utilizing the multi-merchant discount payment system, in accordance with some embodiments; and

FIG. 6 is a second example flow chart for the process of utilizing the multi-merchant discount payment system, in accordance with some embodiments.

### DETAILED DESCRIPTION

The present invention will now be described in detail with reference to several embodiments thereof as illustrated in the accompanying drawings. It should be noted that references to “an” or “one” or “some” embodiment(s) in this disclosure are not necessarily to the same embodiment, and such references mean at least one. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

The present invention relates to a novel and improved means, systems and methods for providing multi-merchant discount payments. These systems and methods may be similar in look and feel to traditional gift card schemas in order to appeal to consumers. However, on the backend, handling of payments is uniquely fashioned to enable the consumer to benefit not only from a multi-merchant payment, but also the ability to do so while realizing a discount paid over the face value redeemed.

Note that while much of the discussion contained herein relates to a payment system that employs a “multi-merchant gift card” (or simply “card”), embodiments disclosed herein also anticipate the usage of virtual cards, account linkage and increasingly applications on mobile devices. As such, while the term “card” may be utilized within the specification to delineate the means of identifying the user account to a merchant, this term is not intended to be limiting, but rather is intended to convey any account identifier, such as mobile device application, biometric data, passcodes, smartcards, RFID chips, or any other conceivable identifier. The account balance, user linked information and the like may be stored upon a cloud or other backend system. The “card” is merely a means for accessing this stored information. As such, a user may have a mobile application “card” and a traditional plastic card linked to the same account information. Further, the “card” may merely be a username and password combination that is remembered by the user, biometric identifier or any other authenticating system. In this example, the username and password could be input at the cash register of a merchant to pay via its linked account.

The following description of some embodiments will be provided in relation to numerous subsections. The use of subsections, with headings, is intended to provide greater clarity and structure to the present invention. In no way are the subsections intended to limit or constrain the disclosure contained therein. Thus, disclosures in any one section are intended to apply to all other sections, as is applicable.

### I. System Architecture

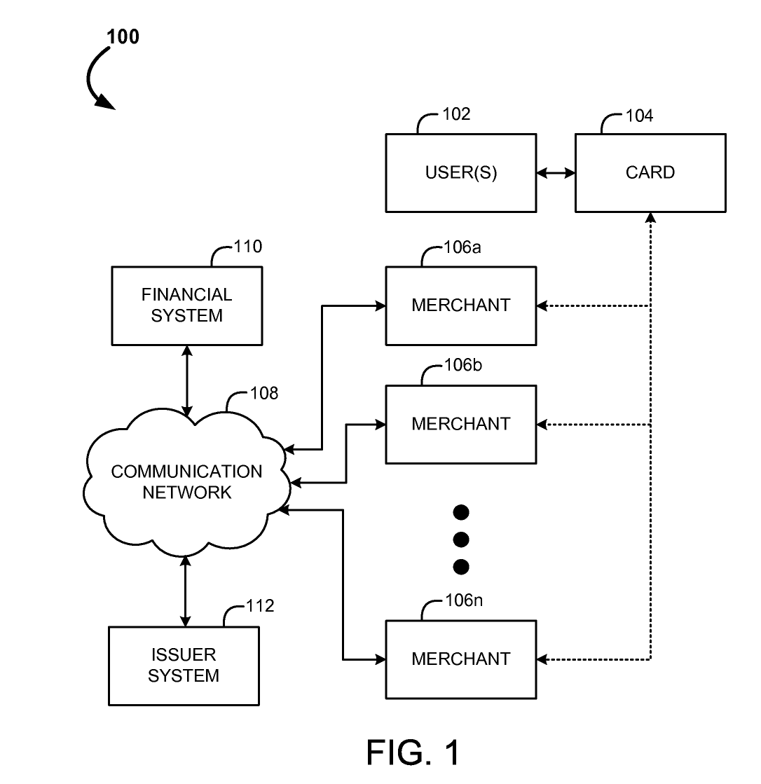

To facilitate the discussion, FIG. 1 is an example functional block diagram for a system of multi-merchant discount payments 100, in accordance with some embodiments. Such systems may provide the consumer (also referred to as the user 102) the ability to purchase, with an up-front discount, a restricted use payment means that may be redeemed at a multitude of merchants 106a to 106n. While the bulk of this disclosure will refer to the user 102 as a personal consumer, the user 102 may also be a business or other association. For example, in some embodiments the card may be issued to internal groups within a network or with external social network groups, such as Google+ circles for selected friends and family members, if there is a group support in the provided API to access them. This expands the gifting opportunity beyond a person giving a gift to another person (person-to-person), to a group-to-person, person-to-group (for example, a donation) and even group-to-group gifting arrangements. Business accounts may be free or paid, depending on factors such as volume, services provided, etc. For companies, the issuer can also provide an API, a set of web services or other means to perform direct transactions with the issuer's backend system. Direct transactions with the issuer mean that that no other organization is involved; the money is transferred between accounts in the issuer's network (alternatively, they can be transferred between bank accounts that are linked to issuer's accounts), allowing free or very affordable money transfers or P2P/P2B micropayments with the value of receiving money being greater than the value initially deposited by the sender.

All merchants 106a to 106n may be in the same category (restaurants, movie theaters, etc.) and the issuer may decide to offer several card lines to serve multiple categories with possibly different discount rates (merchant-or category-dependent), or they can be from multiple categories and use only one card line. If both generic (base) and category-specific cards are implemented, the base cards may still be accepted everywhere a category-specific card is accepted. Alternatively, multiple card lines can be implemented based on discount level (for example, blue, red and gold for 7%, 8% and 10% discount levels). In alternate embodiments, the merchants 106a to 106n may be grouped together based upon other criteria, such as size (i.e., small boutique merchants), or functional relationships (for example, restaurants, wine tasting and movies for a “date night” card line).

The merchants 106a to 106n may be selected via open enrollment, invitation extension to popular retailers, or by geographic location. In some embodiments, crowd-voting for new merchants may be implemented: if a merchant is not currently participating, members can add them to a wish list, then vote; when enough people vote for it, a request is sent to the merchant proposing to join the program. By signing up more partners, it is possible to provide more services, such as letting the customers make car payments with this card or pay mortgage with a possible one-time setup fee. In some alternate embodiments, the participating merchants list can be made of non-competing merchants; alternatively, if competing merchants are selected, the issuer can give exclusivity (possibly for a limited time) to one merchant (for example, to the highest bidder).

This system enables a merchant 106a to 106n to distribute coupons and special deals to a card user 102, or they may disable their other offers and benefits, such as use of a loyalty card or further discounts, when using the card (and possibly offer a bigger discount for card owners). Alternatively, the card itself can be used to accumulate discounts, bonuses, etc.

In some embodiments, the means for making the restricted payment may include a card 104, such as a multi-merchant gift card. In some embodiments, the card may be a stored-value card. A physical card can be a plastic card of various shapes and designs with a barcode or magnetic strip, or it can be an optical (for example, CD), electronic (such as EPROM, EEPROM, and flash memory) or magnetic storage device, microchip or another suitable device. In some alternate embodiments, the card 104 may include a virtual card, mobile phone application, a “smartcard”, or an identifier that links back to an external account database. Such identifiers could include a passcode, an existing credit card or ID, an RFID, or biometric data. Passcodes could include any of barcodes, QR codes, scan codes, or even an alphanumeric code. A virtual card can be an emailed code/electronic message (such as MMS/SMS message, tweet, etc.) or a mobile gift card such as a smartphone scan image, or it can be based on other characteristics such as phone number or address. In some cases, the card may include more than one identification mechanisms, such as an optical tag and a plurality of magnetic strips, thereby enabling many ways of redemption and multiple affiliations.

The card may be used through various interfaces, such as POS terminal, optical reader, Infrared or RFID reader, Bluetooth, USB, or another wired or wireless interface; it may also be used through a website using secure electronic communications and other security methods (such as Captcha). The stored information and transmission may be encrypted. Also, for security reasons, PIN (in certain cases can be default) and/or Web/phone/retailer activation may be required. As can be appreciated by one skilled in the art, any number of known or yet to be developed technologies may be employed as a card 104. The card may also be used for many other functions such as to enter/change PIN, type a message, play games or perform online transactions. However, for the purpose of simplicity in the following examples and descriptions, the card 104 may be referred to as a card, as the usage of gift cards is well understood.

Merchants may have a physical presence or they can be pure online companies; the card 104 value can be in a regular currency (for example, USD) or in virtual currency (online credits) or some other variation (such as a hybrid currency, electronic money such as digital gold currency, etc.).

In some embodiments, the system described may be implemented on the vendor side by depositing an initial large amount into a pre-set account of the merchant 106a to 106n, such as gift card account (to cover merchant 106a to 106n setup expenses, demonstrate commitment, etc.). The account associated with each merchant 106a to 106n may be replenished with funds when it drops below some configured threshold. The numbers (initial funding amount, etc.) can be the same for all vendors or be based on each merchant's individual contract.

Refreshing ability of funds may depend heavily upon the backend workings of the system. For example, in some alternate embodiments, the merchants may contract to draw against an independent account held by the issuer once the user 102 uses the card 104 to make a purchase. The merchants may be required to pay periodic fees to participate in the program. They are also required to give an advance notice before dropping out of the program. Alternatively, when drawing from the issuer's account, the merchant may contract to draw only some percentage of the value spent in the store. For example, the issuer sells a multi-merchant gift card for 95% of the face value. When the card is used at any participating merchant, the merchant charges the issuer 94% of the value paid for by the card. Effectively this enables the issuer to capture 1% of all purchases. In some other embodiments, some combination of discounting and fees may be employed to ensure profitability for both retailers and the issuer.

Regardless of account setup, the merchants 106a to 106n may communicate with the financial system 110 and the issuer system 112 via a communication network 108. Likewise, the financial system 110 and issuer system 112 may communicate via the communication network 108. In some embodiments, the financial system 110 and the issuer system 112 may be the same entity. In some alternate embodiments, these are separate entities. The communication network 108 may include any wide area network, private network, secure and private network, or open network. In some embodiments, the communication network 108 may include the internet. Financial institutions already have dedicated networks and means for internet commerce that may be leveraged by the present system to effectuate its functionality, as known to those skilled in the art. Generally speaking, any known communication method that is practical may be used as the communication network 108 (the main information that is needed is usually the account number, with possible additional several fields), together with the appropriate gift card form and the reader (a device/interface/reader combo).

The financial system 110 may include a bank, credit union, loan agency or the like. The issuer system 112 may issue the card 104 and manage transactions. The issuer system 112 may also be a financial institution or may be some unrelated third party. Additionally, in some embodiments, the issuer system 112 may be a merchant consortium, or trade association, or professional entities (for example, a branded/customized card for a dentistry office or law firm used to thank loyal customers). In addition to its role as a card processer, the issuer system 112 may be able to analyze user 102 spending profile and maybe sell this information, can advertise on the card 104, develop relationships with individual consumers, and strengthen relationships with merchants.

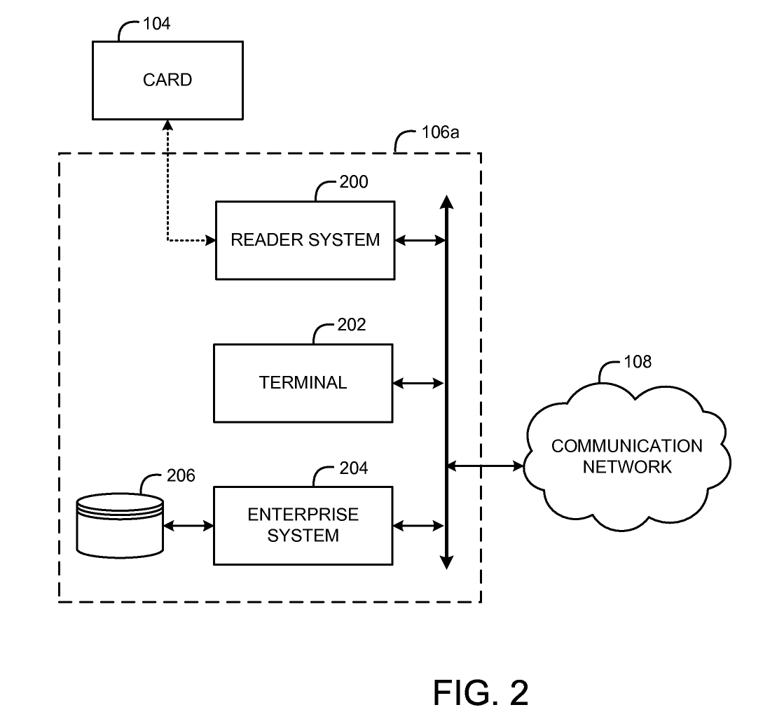

FIG. 2 is an example block diagram for a merchant 106a to 106n, in accordance with some embodiments. A reader system 200 at the merchant 106a to 106n may read the data of the card 104 in order to access the proper account information. In the case where the card 104 includes a traditional style plastic gift card, the reader system 200 may read the card using an optical reader or magnetic strip reader. In some embodiments, the reader may include wireless transceivers (in the case of RFID or mobile applications as the card 104), contact chip readers, other direct contact implementations, or may include even more exotic means for reading the card 104 (such as retinal scan, fingerprint, etc.). Those of skill in the art will appreciate that a gift card can have a plurality of different interfaces (and be able to work with multiple merchant reader devices), with either manual selection of the interface to use (for example, choosing between sliding a magnetic strip and scanning an optical image) or an automated interface selection unit. Additional security measures such as encryption and biometric identification can also be implemented.

The reader system 200 may couple to a terminal 202 and, in most embodiments, an enterprise system 204 which manages inventory, sales records, etc. The enterprise system 204 often may access a database 206 for long term storage of Point of Sales (POS) data.

In some embodiments, the terminal 202 or the reader system 200 may couple to the communication network 108 and convey the information found on the card 104 to the financial system 110 and issuer system 112 for processing. Once processed, the reader system 200 or terminal 202 may receive confirmation of payment thereby allowing the user to finalize the purchase of any good or service.

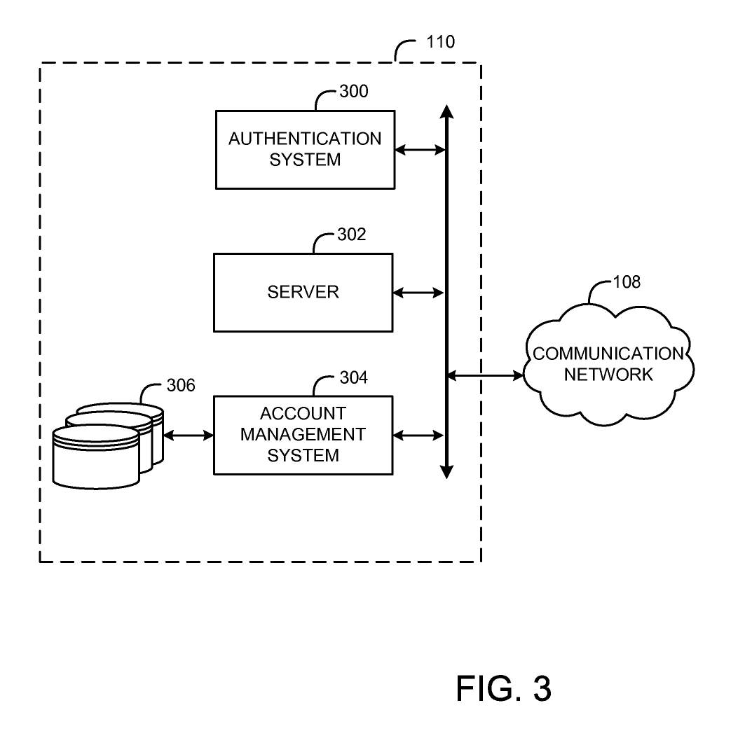

FIG. 3 is an example block diagram for the financial system 110, in accordance with some embodiments. The financial system 110 may include an authentication system 300 that not only verifies the authenticity of the card 104, but also ensures that a valid merchant 106a to 106n is requesting the transaction. The financial system 110 also includes a server 302 and an account management system 304. The account management system 304 may control a plurality of storage devices that contain accounts information 306. The server 302 may coordinate access to the account management system 304 via the communication network 108.

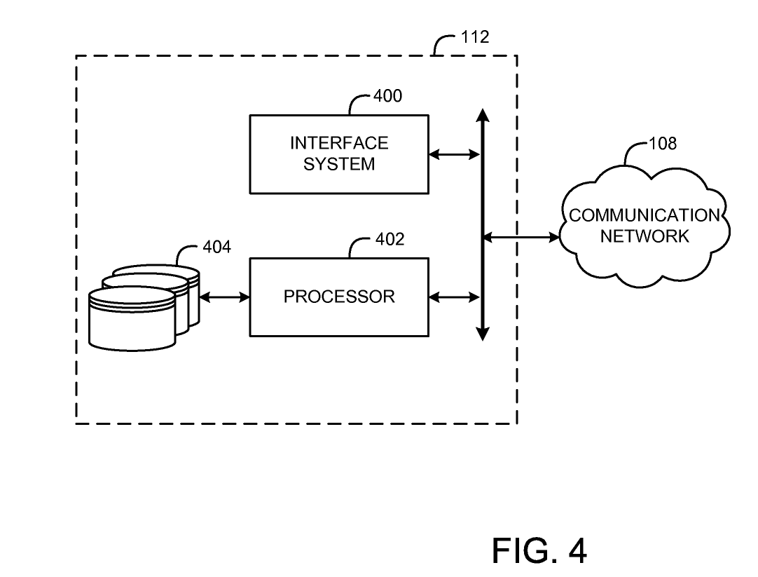

FIG. 4 is an example block diagram for the issuer system 112, in accordance with some embodiments. The issuer system 112 may include an interface system 400 and a processor 402. The interface system 400 would mediate communication between the communication network 108, and further could be utilized by the user 102 to purchase, or further fund, cards (in our traditional card based example). The processor 402 may perform the processing of a transaction. Storage devices 404 may couple to the processor 402. This storage may include account information, user data, and financial institution data.

In one example where a card is utilized as the card 104, the user 102 uses the card at a merchant 106a to 106n. The merchant store can be a brick and mortar (B&M) store, a business to consumer (B2C) website, etc. The merchant's card processing system, such as a POS terminal 202, reader system 200 or Website backend system, sends a processing request to the processor 402 of the issuer system 112. The request is then forwarded to the financial system 110 such as merchant's gift card system, which processes it using the pre-funded gift card account 306 and sends a reply back to the issuer system 112. This reply is then forwarded back to the financial system 110 after deducting the purchase amount from the customer card balance in the issuer system 112.

In some embodiments, rather than maintaining prefunded accounts at the financial system 110 for each merchant 106a to 106n, the financial system 110 may contain an account for the issuer system 112 that is utilized to pay the merchant 106a to 106n when a purchase is made. In these embodiments, the merchant 106a to 106n must trust the issuer system 112 more than in a pre-funded scenario, however, this allows the issuer system 112 to maintain all funds until disbursed, which may have economic advantages to the issuer system 112 and prevent overfunding of a merchant 106a to 106n that is ceasing its participation in the program.

### II. Methods of Use

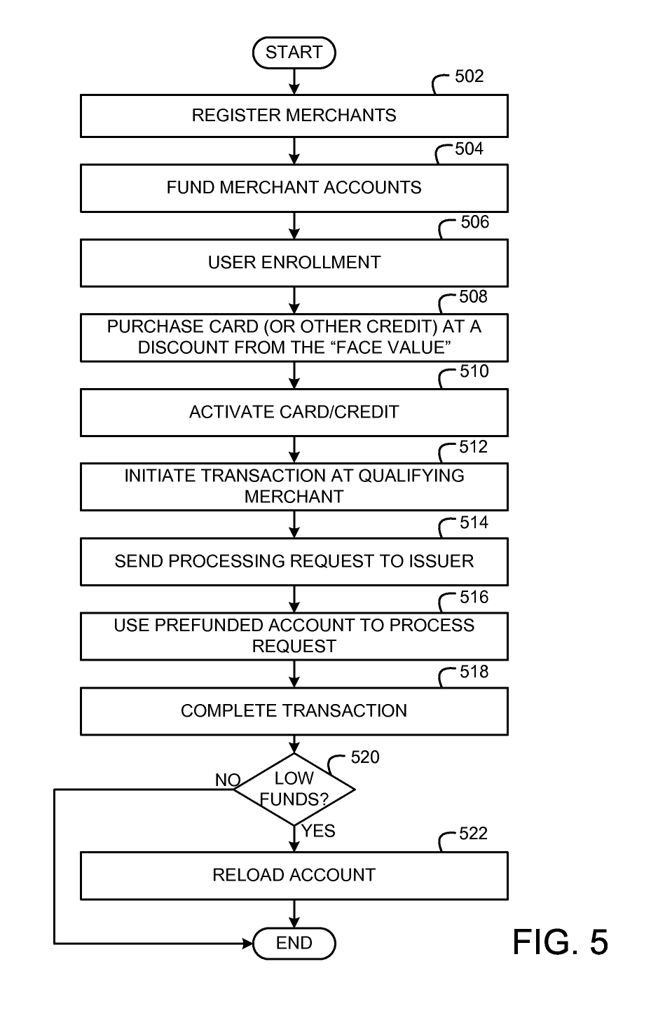

FIG. 5 is a first example flow chart for an exemplary process of utilizing the multi-merchant discount payment system, in accordance with some embodiments. The process flow depicted is merely an exemplary embodiment of the invention and is not intended to limit the scope of the disclosure contained herein.

When a merchant desires to participate in the program, the merchant may register as a participating merchant 106a to 106n (at 502) by submitting certain merchant data to the issuer system 112, such as, for example, merchant ID and the information about the gift card account number registered with the program.

Next, the merchant's gift card account number for the program is funded by the issuer system 112 (at 504) using any suitable method. The initial funding levels, as previously mentioned, may be dictated by mutual agreement between the issuer and the merchant. Typically initial funding levels are larger than later thresholds in order to cover the merchant's costs for system overhead, and also to generate trust between the merchant and the issuer system.

In some embodiments, the issuer may become the catch-all processor for all gift cards: for example, if a gift card is used at a merchant that is not issued by the merchant and not the issuer's gift card, the transaction is still routed to the issuer and can be approved, if the issuer determines that this is a gift card of one of its partner merchants and routes it to the merchant after subtracting the processing fees (the customer may be charged a fee for this service).

A user 102 may register or enroll (at 506) to participate in multiple merchant discount gift card system by any methods known and practiced in the art, such as over the phone or internet. Encryption methods such as Secure Sockets Layer (SSL) encryption may be used to provide secure Internet communications for consumer sessions. Other means, such as Captcha, may also be employed on the Website. Alternatively, a messaging or texting service may be used to access the account and perform various functions. Upon enrollment, the consumer account is established in the issuer's database. In some embodiments, the user can use this single account for gift cards, money transfers and other financial services.

On the web, a browser add-on or initial authentication with the issuer's website can be used to simplify the subsequent payments on merchant websites and P2P transfers by not requiring the user to log on multiple times (subject to security measures, such as timeout, and possible enhancements to these websites to accept these payments).

Once the customer enrollment process is complete, the consumer may use any of multiple payment vehicles, such as check or credit card, electronic payment method such as PayPal or Neteller, bank check, cash, ACH/wire draft or other acceptable payment method, to purchase the issuer's gift card (or other suitable credit) at a discount to its face value (at 508). This discount can be a fixed percentage for all participating merchants or it can vary based on some factors such as merchant popularity, category or size of card purchased. Often the user purchases and receives the card; however, it is also possible that the card can be ordered for another person and sent by issuer directly to that person (subject to security verification); it may also allow somebody other than account owner to add money to that account. This expands the usage of this discount multi-merchant card as a unique and thoughtful gift.

Although, in most embodiments the card is disclosed as being a prepaid card type, in some embodiments the card may be a debit/credit card hybrid, where credit is extended to the user.

Some implementations include a range of initial balance values for virtual/smartphone/etc. cards (for example, $20-500) and a set of fixed values for physical cards (for example, $50, 60, 100, 120, 150, etc.). Card may be purchased directly from the issuer, in some embodiments, or may be purchased from participating merchants. A self-service kiosk may be used to accept cash, checks, etc., at a discount and add money to the account associated with the card; can also be reloaded from an ATM, via website, etc. If the card is purchased from a merchant, the merchant (or customer) scans the card's barcode, swipes the card's magnetic strip, and/or otherwise inputs card information at a merchant's reader device, such as a merchant terminal. Other methods to input such information, such as using a smartphone/PDA or scanning a computer printout, may be used. If the card is not pre-associated with a specific value, the customer may specify a particular value which may then be input at the terminal. This defined value would then become the card's associated value, unless and until the associated value were later changed by the customer, merchant, or issuer. If a PIN is not pre-printed on the card, the central processor may also transmit a PIN to the merchant terminal upon activation of the card; the merchant terminal may then distribute the PIN to the customer.

In some embodiments, the customer may select the card type and design from among a plurality of different available options. For example, the customer may select a New Year-themed plastic card with a magnetic stripe or a Bluetooth Birthday Wish card. In some embodiments, a picture/video/etc. can be on the card itself or on the packaging. This picture or video (2D/3D) can be displayed/projected (including a hologram image) with a possible help of external accessories (can be on a physical card/packaging or a 2D/3D image/video together with a mobile/virtual card), which can be easily changed by using either a standard file upload or specialized user interface; can also use a predefined image/video.

As previously noted, gift cards are merely one form of payment credit and may be substituted by virtual gift cards, mobile device applications, or any other suitable identifiers liked to external accounts.

The card/payment identifier is activated (at 510), which may include setting the active flag in the issuer's database. In some embodiments, the card does not require a separate activation step (it is delivered already active). In some embodiments, a security code, such as PIN (personal identification number) can also be associated with the card number. If user declines to use PIN in these embodiments, a predefined (for example, all zeros) value can be used. For the embodiments, when the card is bought in a physical store, the card can be instantly activated by the retailer, also possibly using PIN. Generally speaking, a PIN can be set up by the issuer (and stored on the physical card, usually using a protective layer that needs to be scratched; or sent in a separate mail for an electronic virtual card, or stored in a computer system), created during the activation process, or set up by the user using a website, phone or an electronic terminal. Other methods to enhance the security of the card may include a biometric check, verification against a photo identification presented by a user at a retail store or an alphanumeric password, for example.

In some embodiments, the card has at least a card number and an associated PIN. The card number is assigned by the merchant and may be the same as the account number or a serial number. The PIN (or other numbers) may be hidden on the card so that they are not visible until after purchase, for example, to be covered by some material or tape. These and other methods for securing valuable card information are well-known in the art. The card may have other numbers, for example, for additional security checks or processing.

The card information, such as the card number, value and PIN may be stored in a database 404 at the issuer's computer system. These numbers may be associated together in a single entry for a single stored-value card. The ability to merge multiple entries into one (to combine cards) may also be possible.

An account management system may be provided, in some embodiments, to allow merging multiple cards into one account and transfer the balance between different accounts with or without a physical card. There is also an auto-reload feature that allows automatic re-loading of the card when its value drops below a pre-defined limit. Instant reload should be possible only if the account is linked to a financial account (for example, to a checking account, with a credit card as a backup funding source) and automatic re-loading is enabled for the card in the issuer's computer system. The account can be set up to allow other people to use the user's account: for example, by creating sub-accounts or otherwise giving use permission to the people the customer trusts, for example as a family card, where each registered member shares the responsibility for it. Further, in some embodiments, a limited time, predefined balance virtual or smartphone gift card can also be generated (a minimum amount restriction may apply).

With customer enrollment, card activation and active account management in these embodiments, the present system grants the user the ability to get the same stable discount over and over as well as getting an access to the purchasing history and complete safety in case the card is lost (currently, if a traditional gift card is lost or stolen, it usually cannot be replaced). Further, by tying the card to a specific user (or set of users) periodic balances, unusual activity and the like may be supplied to the user via email, SMS, Twitter, Facebook messaging or the like. The user may also link Twitter (or similar) accounts to the card in order to enable remote balance checks and transactions from a mobile device via Tweets.

The account number format may be same or similar to credit card numbers or merchant gift card numbers; in this case, a close cooperation with other entities such as the American Banking Association and merchants may be needed to avoid the conflicts with existing or future card numbers. In some embodiments, the card number is a sixteen digit numeric value, which has not been previously assigned to an existing credit card account, so as to be compatible with conventional credit card transaction processing systems.

In some embodiments, the card may also show activation information instructing the customer how to activate the card. The information may comprise a 1-800 number (or other 8xx number or other phone number), an IVR input code or series of inputs, a website, and/or other information or instructions. The redemption instruction information may be printed on the card, or it may be printed on a receipt and provided to the customer upon purchase of the card or sent electronically (i.e., email, text). If the activation is done after the purchase of the card, the customer may use a phone system (such as IVR), Website, messaging or texting service or other means to activate the card. An Interactive Voice Response System (IVR) is a computerized telecommunications element that receives incoming calls and directs them through a telephone system often using voice recognition and telephone keypad entry. The authentication may include checking callers' identification to ensure the call is from the phone number of the intended recipient and answering pre-defined challenge questions.

If the card is gifted, the final recipient may, in some embodiments, have an existing account or create an account before using the card. The card then can be claimed using the card number and PIN. In some embodiments, the card can also be marked as gifted before it is claimed by the recipient. Alternatively, there may also be an option for the final recipient to redeem the card without claiming it. When the card is gifted, auto-reload option may also be disabled; it can be added by the recipient of the card. When gifting the card, a text (written or electronic), audio or video message can be associated with the card, in some embodiments.

The end result of the activation is that the card is marked as active in the issuer's computer system. Additional activation requests may be made for the card, in some embodiments. For instance, after purchasing a card from a merchant terminal and activating the card, the customer may recharge the value of the card any number of times at any number of merchant terminals, including the same merchant terminal(s). The customer may also recharge the card via the Internet, telephone or text messages. The customer may also specify various parameters during recharge, such as a new value and new PIN.

The customer makes a purchase by using the card (at 512). In some embodiments, all participating merchants are listed on the issuer's website. These merchants may also indicate the acceptance of the card by using its brand mark, such as online logo, door decals and point-of-sale signage. A location-based app can also be used to let the user know that a nearby business accepts the issuer's card. For the new merchant applications, a voting mechanism can be implemented for the already participating merchants to determine whether the application is to be accepted or rejected. The full account amount (not just the discounted purchase price) is available for redemption at all participating merchants. When making a purchase at a participating merchant, the consumer presents the issuer's gift card, which causes the merchant's card processing system, such as a POS terminal or Website backend system, to send a processing request to the issuer's processing unit (at 514), such as issuer's backend computer system. The decision to do so may be based on certain digits or combination of digits in the card number or on other factors.

The merchants may be able to utilize existing processing networks for processing purchases made using the card, or the card may be processed by the issuer's own network. For example, many POS devices are preprogrammed to recognize gift cards, mall cards, etc. The information such as card number, PIN, purchase amount and so on is provided to the merchant by swiping a card through the device, using a web tool, scanning it with an optical reader, inserting it into a USB slot, manual entry or other means. The merchant's reading device may encrypt the data to be sent. The data is then sent either directly or via another entity or system to the issuer's computer system. The issuer's system verifies the data (at 516) and then forwards the data to the merchant's gift card processing system or the bank processor. The issuer's computer system may also access the merchants' website or other computer interface and it may add other account-related information (such as user name, address, etc.) to pass along with the card data. All the connections can be made via a toll-free telephone line, a dedicated phone line, wireless network, over the internet, or any other standard communication means. After processing the transaction, the approval (which may contain an authorization number and other information) or rejecting message (which may contain the error code and other information) is sent back to the issuer and then forwarded to the merchant (at 518). The issuer will also do some processing, for example, decreasing the balance of the card in case of successful transaction, and transferring funds from the pre-funded account to the merchant. During the processing, various error handling mechanisms should be used to ensure the integrity of all systems.

In some embodiments, the transfer of funds to the merchant may be instantaneous. This is a competitive advantage over ACH transactions where the merchant does not receive the funds until the ACH transaction settles, which may take 2-8 days. In some cases, this instantaneous funding may be associated with a fee to the merchant; alternatively, merchant payments may be delayed a few days to mirror ACH transactions for no fee.

If the balance of the card drops below a pre-defined amount (determined at 520), it can be automatically reloaded (at 522) if auto-reload option is enabled for this card. Re-loading the card consists of adding a value to the card and re-using it. Each reload is recorded by the issuer's computer system. Reloading a card rather than getting a new one reduces the environmental impact.

Otherwise, if the balance drops below a pre-defined amount, for example, 25 cents, and the card is not marked as reloadable (linked with a funding source), then the balance immediately becomes zero. The account is then closed; card would become de-activated and could be disposed of.

To promote card reloading, discount rates can be manipulated to incentivize continued card usage. For example, if a card is marked as reloadable, the discount on funds that are added in reloads may be the same as what was used during the original purchase. In some alternate embodiments, if the initial discount rate was less than the online one (for example, for purchases from retail stores), then the reload rate is whatever it would be if bought online. The discount rate may also move up with reloads in a multi-tier discount system: for example, if the discount rate is 5% for purchase amounts up to $ 200 and 6% for all amounts larger than $200, then the reload discounts is adjusted upward to 6% after the cumulative purchase has reached $200, even if the original discount rate was 5%.

To minimize the possibility of fraud, it is recommended that the user should be required to specify the maximum amount of reloads in dollars (for example, per day and per week). Reloadable cards can be integrated with another financial instrument (such as online banking) and be used by others for various purposes.

As can be appreciated with one skilled in the art, a possibility may be provided to convert between various gift card formats (for example, from a plastic card to a mobile gift certificate). Another possibility is a conversion from one of the participating merchant gift card to the issuer's card for a fee. When the network of users grows beyond one country, the issuer can provide foreign exchange services at a profit (i.e., for international gift cards, money transfers using own or partner networks, etc.) while providing a discount to the deposited money value. Also, a gift card itself can consist of an electronic transfer of funds (EFT) possibly coupled with a video/audio/text/picture message. The benefits of the conversion include a wider acceptance and the ability to merge with the existing account of the issuer's card. Yet another option is redeeming the card for cash, also for a fee at least partially based on the card's face value. This may be accomplished by transferring the value of the card to a bank account for cash at the discounted purchase price and a convenience fee. Likewise, in some embodiments the card may even be usable at an ATM for withdrawal of funds at the discount rate (less than card face value) plus associated convenience fees. For example, a user may purchase a multi-merchant gift card with a face value of $100 for the discounted price of $90 (a 10% discount). The user then purchases an article of clothing from a merchant for $40, thereby reducing the card's face value to $60. The user then decides to use the card at an ATM for spending cash. If the user withdraws $20, the face card value will be reduced by $22.22 (the face value corresponding to the discounted $20). An additional $2 fee may also be applied for the transaction, in this example. The card will then have an available face value of $35.78.

To minimize the possibility of fraud in these cases, it is recommended to implement additional security measures such as that the user is allowed to do these transactions only from his/her own account. Other restrictions may include requiring buying the pre-defined minimum amount of the issuer's cards before enabling this option in the user's account and specifying the maximum limit for conversions and cash redemption per time period.

At pre-defined intervals, a report may be created between the card issuer and participating merchants so that their accounts can be reconciled. Transfer of funds between these parties may take place by any commercially acceptable means such as a file, API, web service call or another mechanism.

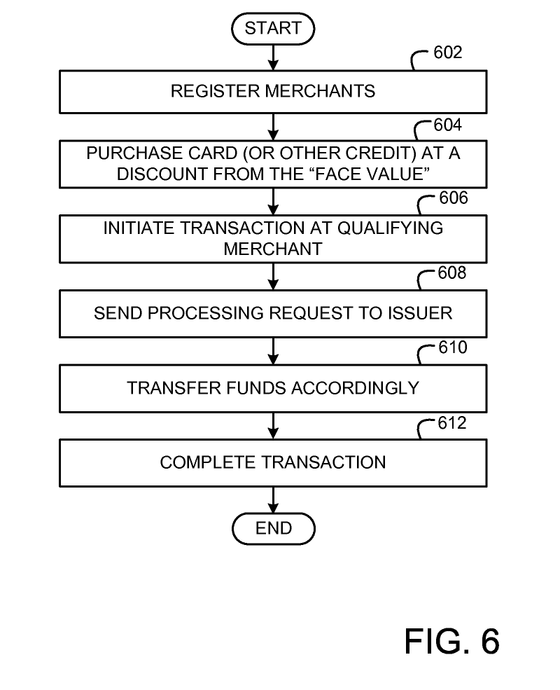

Some embodiments of the present invention may be further simplified. FIG. 6 provides an overview of such a simplified process. Markedly, in this instant process there is no requirement for setting up a prefunded account with merchants, or registration of the user. While such simplifications make the system more attractive to some consumers due to the reduction in requirements upon them, it may lead to a less robust experience (i.e., no auto-reload, reduced fraud protection, etc.). Further, such an arrangement requires a great deal of contractual agreement and trust between the issuer and the merchants.

In this system, the merchants register with the issuer (at 602). Merchant registration includes contractual obligations that the merchant will accept the cards disbursed by the issuer. Typically, the merchant will also agree to charge the issuer's bank account some reduced percentage of total invoices for payments made with the card. In essence the merchant is trading the issuer a discount for increased sales and market share. The issuer may then transfer some or the entire discount on to the card user.

The user purchases the cards (at 604) for a reduced price. Again, purchases may be at the merchant, online, or through other known retailing mechanisms. Unlike the previously disclosed process, in this minimalistic process, the card does not necessarily require activation. In this process, the cards are more akin to cash. This means that cards require less activity on behalf of the user, but are more easily stolen or otherwise lost.

The user may then utilize the purchased card to initiate a transaction (at 606) at a qualifying merchant. The merchants system sends a processing request to the issuer (at 608) which includes a charge that is at a discounted level than the face value of the purchase (as delineated in the merchant contracts). The funds are transferred (at 610) from the issuer account to the merchant. The transaction is then finalized (at 612).

When a consumer wishes to return a good purchased using the multi-merchant discount card, the returns of goods can be processed as card loads; the return can be made to an issuer's card (not necessary the one that was used to make the initial purchase) or to the retailer's gift card (for a possible fee).

In some embodiments, the issuer may purchase several gift cards from merchants in bulk denominations in order to receive a large discount, and then provide aggregated gift cards with a smaller discount to end users. Further, it may be possible that the issuer may also purchase bulk volume of gift cards from a merchant in popular denominations, and then resell these cards at a reduced discount. Such a system may complement the issuance of multi-merchant cards to meet the desires of the consumer base.

In sum, the present invention provides systems and methods for multi-merchant discount payments. Such systems and methods may enable users the ability to have a system similar to traditional gift cards, but overcoming the largest drawbacks associated with such systems: namely, single merchant availability, and lack of discounts.

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention.

It should also be noted that there are many alternative ways of implementing the methods and apparatuses of the present invention. The described embodiments are not intended to be exhaustive or to limit the invention to the precise forms disclosed. The presently disclosed embodiments are, therefore, considered in all respects to be illustrative and not restrictive. The embodiments were chosen and described in order to best explain the principles of the invention and its practical applications; they thereby enable others skilled in the art to best utilize the invention and various embodiments with various modifications as are suited to the particular use contemplated. It is therefore intended that the following appended claims be interpreted as including all such alterations, modifications, permutations, and substitute equivalents as fall within the true spirit and scope of the present invention.

What is claimed is:

1. A method for operating a discount multi-merchant gift card system comprising:
registering a plurality of merchants;
issuing a card with a unique identifier to a user after receiving a payment of a discounted amount, which is less than full face value of the card such that the user realizes the discount at the time of purchase, wherein the card has the purchasing power equal to the face value at any of the registered plurality of merchants, and wherein the unique identifier indicates the card type;
pre-funding an account corresponding to each of the plurality of merchants;
receiving a communication when the card is used at one of the plurality of merchants for a transaction; and
processing the transaction.

2. The method of claim 1, further comprising activating the card.

3. The method of claim 1, wherein the card is a smart card including at least one of a chip, a transmitter, camera, touchscreen, and a power source, and wherein the smart card communicates in the radio waves to ultraviolet range of the electromagnetic spectrum, including the use of small changes in electromagnetic intensity and/or changes in wave length, and wherein the power source uses at least one of solar power, battery, fuel cell, piezoelectric materials, external voltage differentials, electromagnetic waves and ultrasound waves, and the resulting energy may be stored for later use.

4. The method of claim 1, wherein the card comprises at least one of a plastic card with at least one of an optical identifier or magnetic strip, an RFID card, an application on a mobile device, a USB device, a laser optical card, an SMS/MMS message, and a virtual card.

5. The method of claim 1, further comprising enrolling the user, wherein enrollment includes collecting user specific information.

6. The method of claim 5, further comprising maintaining a database storing the card unique identifier and user specific information.

7. The method of claim 6, wherein the user specific information includes records for user accounts for issued cards, each record including card number, user name, user address, activation flag, and remaining balance.

8. The method of claim 1, further comprising reconciling the received transaction against actual transactions occurring in merchant systems.

9. The method of claim 1, wherein the card is branded.

10. The method of claim 6, wherein the card is associated with a financial account of the user.

11. The method of claim 10, further comprising reloading the card in response to at least one of a user request and/or the balance dropping below a threshold, wherein the reloading is performed at a discount of the reloaded value.

12. The method of claim 1, wherein the card is protected from unauthorized use by using a personal identification number, cryptographic methods and personal information verification.

13. The method of claim 1, further comprising enabling more than one card to be merged, and the transfer of card balances between different accounts.

14. The method of claim 1, wherein the card is one of a plurality of card types, and wherein the card types are based upon discount levels and merchant categories.

15. The method of claim 1, wherein the discounted amount is based upon at least one of merchant popularity and merchant category.

16. The method of claim 1, wherein the transaction is for at least one of physical goods, virtual goods and services.

17. The method of claim 1, further comprising maintaining a database of records for the pre-funded accounts for the plurality of merchants, each record including the merchant identification, account number and remaining balance.

18. The method of claim 1, further comprising converting the face value of the card to another account for a fee.

19. The method of claim 1, wherein the face value of the card is at least one of regular currency, virtual currency, and a combination thereof.

20. The method of claim 1, further comprising purchasing bulk gift cards from each of the plurality of merchants at a reduced price in order to pre-fund the accounts.

21. The method of claim 1, wherein the card is used with internal groups within the issuer's network of users or with external social network groups to facilitate person-to-person, group-to-person, person-to-group, and group-to-group gifting opportunities.

22. A method for using a discount multi-merchant gift card system comprising:
purchasing a card with a unique identifier for a discounted amount, which is less than full face value of the card, wherein the card has the purchasing power equal to the face value at any of a plurality of registered merchants, and wherein the unique identifier indicates the card type; and
transacting at one of the plurality of registered merchants for goods or services using the card.

23. A method for transacting a discount multi-merchant gift card system comprising:
registering with a card issuer, wherein the registering includes being grouped with a plurality of other merchants;
receiving a prefunded account from the card issuer;
debiting the prefunded account when a user with a multi-merchant card purchases good or services; and
paying the issuer a fee.
